(19) United States
(12) Patent Application Publication
(10) Pub. No.: US 2008/0307613 A1
(43) Pub. Date: Dec. 18, 2008

(54) Pipe engageable safety line anchor

(76) Inventor: James D. Woods, Vista, CA (US)

Correspondence Address: DONN K. HARMS;PATENT & TRADEMARK LAW CENTER, SUITE 100, 12702 VIA CORTINA, DEL MAR, CA, 92014, US

(21) Appl. No.: 11/818,140

(22) Filed: Jun. 12, 2007

(51) Int. Cl. F16G 11/14; A44B 21/00

(52) U.S. Cl. 24/298; 24/115 R

(57) ABSTRACT

A pipeline-engageable safety line anchor having a base adapted to an engagement with the curved exterior surface of a pipe. The base may be formed to fit the curve of the pipe or may be flexible and thereby adaptable to follow the curved exterior surface of the pipe. A strap provides an attachment of the base portion in a tensioned engagement around the pipe and with the base. Eyes or other engagement points for a safety line attached to a user provide engagement points for the safety line.

### FIELD OF THE INVENTION

The disclosed system and method relates to safety harnesses and tethers for workers on elevated job sites. More particularly, it relates to a device providing an engagement for a tether which is adapted for attachment to the curved surface of a large pipeline and for the attachment thereto directly or indirectly of a safety harness worn by a person working upon the elevated upper surface or on ladders or scaffolds along the side surfaces of the pipeline.

### BACKGROUND OF THE INVENTION

Government and industry regulations and standards make it an ever increasing requirement for persons working on jobs elevated above the ground to provide against the possibility of accidental falls to the ground below. Since a fall of quite a short distance can cause serious injury or even death, the provision of such a safety means is desirable when the height of the surface above the ground is as small as about 2 meters (6 feet), and some jurisdictions now require a safety installation of some kind for all work above this height.

Conventional harnesses comprise a safety harness for each worker that is releasably engaged on one end of a tether line with a snap hook or shackle. The other end of the tether line is engaged to a securing point on the elevated structure. Such a securing point or points must, of course, be strong enough to withstand the forces applied thereto by a falling body which increases the force upon the engaged tether. The securement point must also be high enough to permit use of a tether line long enough not to obstruct free movement of the worker on the work surface, while short enough for a falling body not to reach the ground.

On large pipelines the worker is frequently faced with the prospect of walking on top of the pipeline being assembled from smaller pipe increments, or working on ladders and scaffolds elevated above the ground surface which allow access to work on the sides of the large pipe. However, it is extremely difficult to provide securement points to pipeline workers which are suitable for tether engagement, which allow freedom of movement, which can readily be attached to the pipeline structure as and when required, and which also can readily be removed when the job is finished to be employed elsewhere. Additionally, because of the nature of pipelines constructed from steel or concrete pipe sections, it is not possible to engage into the sections of pipeline themselves because of the risk of damaging the structure of the eventually finished pipeline.

Accordingly, there is an unmet need for a tether securement device that is adapted for temporary engagement to the curved surface of a pipeline being assembled or worked upon. Such a device should be easily engaged to the exterior of the pipeline sections or wall surfaces and should not in any fashion pierce or harm the surface. Further, such a device should be, in the preferred mode, adaptable for an engagement to a plurality of different curved surfaces to accommodate pipelines and pipe sections of differing diameters.

In this respect, before explaining at least one embodiment of the invention in detail, it is to be understood that the invention is not limited in its application to the details of construction and to the arrangement of the components set forth in the following description or illustrated in the drawings nor the steps outlined in the specification. The invention is capable of other embodiments and of being practiced and carried out in various ways as those skilled in the art will readily ascertain from reading this application. Also, it is to be understood that the phraseology and terminology employed herein are for the purpose of description and should not be regarded as limiting.

As such, those skilled in the art will appreciate that the conception upon which this disclosure is based may readily be utilized as a basis for designing other methods and systems for carrying out the several purposes of the present invention of a device and method providing pipeline workers a tether engagement point for a harness tether. It is important, therefore, that the claims be regarded as including such equivalent construction insofar as they do not depart from the spirit and scope of the present invention.

An object of this invention is the provision an engagement point for a tether for the safety harness of pipeline workers.

An additional object of this invention is the provision of such a tether engagement point that adapts to fit the curve of the exterior of different diamatered pipelines and pipe sections.

Yet another object of this invention is to provide such a tether engagement point that does not harm the surface or sidewall forming the pipeline in any fashion.

Another object of this invention is to provide a method of installing a removable tether securement device to a pipeline or pipe section.

These together with other objects and advantages which will become subsequently apparent reside in the details of the construction and operation as more fully hereinafter described and claimed, reference being had to the accompanying drawings forming a part thereof, wherein like numerals refer to like parts throughout.

### SUMMARY OF THE INVENTION

The disclosed device provides a safety line anchor mountable upon the curved exterior surface of a pipeline or sections forming a pipeline during construction thereof. The safety line anchor includes a base member that is either preformed to the curve of the intended pipe or malleable or otherwise adapted to curve in substantially the same arc as the exterior surface of the pipeline to which it is engaged by its first or bottom surface. Rising from a top surface of the base member is one or a plurality of engagement components having attachment means thereon adapted for engagement of a tether which is also engaged to the worker safety harness.

Means for engagement of the base member to the exterior surface of the pipe section or pipeline is provided by a strap having a length sufficient to encircle the pipe section. The strap engages opposite ends of the base member in a tensioned engagement thereby frictionally engaging the bottom surface of the base member to the exterior of the pipeline section in a temporary but a secure mount. In cases where the pipeline sections are formed of cementitious material such as concrete, the strap may have a width which is slightly smaller than the gaps that are formed in the exterior surface of the assembled pipeline at each sectional engagement of a bell and spigot type connection. This allows for easy passage of the strap under the pipeline by threading it through the gap where the pipeline section sits upon the ground or another support surface. However, the strap can also be adapted to encircle the pipe itself offset from the engagement point should an offset be desirable, such as when the joint is to be welded.

In use, the base member is frictionally engaged to an upper area of the exterior of the pipe section or pipeline by employment of a tensioned engagement of the strap around the pipeline. The two ends of the strap are engaged to the two ends of the base member and then the strap is tensioned and secured in a tensional engagement thereto. Once so secured, the worker may thereafter engage the distal end of a safety harness tether to the appropriate engagement component of the base member. Removal involves de-tensioning the strap and removal or replacement of the base member to another point on the pipeline for remounting.

Other aspects and features of the present invention will be noted upon examination of the drawings, description of the best mode for carrying out the invention, and claims, all of which constitute disclosure of the present invention.

### BRIEF DESCRIPTION OF DRAWINGS

FIG. 1 depicts an end view of the device showing the arc of the bottom surface of the base member substantially equal to the exterior surface arc of a pipe.

FIG. 2 is a depiction of the disclosed device in an engaged position upon a pipeline assembled from engageable pipe components which form a recess in the exterior surface of the assembled pipeline. Adjacent engagement around the pipe may be more desirable if welding is to occur.

FIG. 3 depicts another embodiment of the device having a base member formed of spaced member components engaged with hinges to allow for an adjustable arc to the base member to adapt to different diamatered pipelines.

FIG. 4 depicts the recess formed in the exterior of conventionally cementitious pipelines adjacent to the bell and spigot engagement in assembled from engageable pipeline sections.

### DETAILED DESCRIPTION OF THE PREFERRED EMBODIMENTS

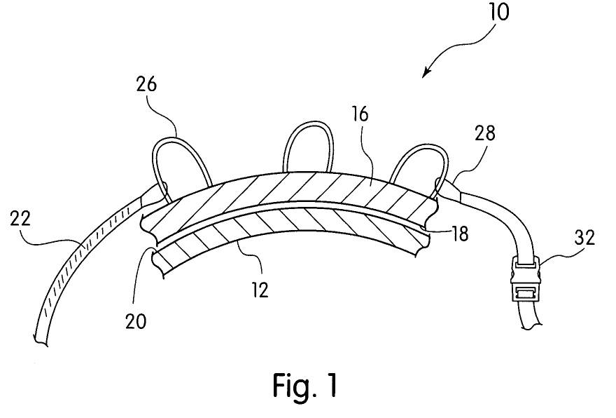

Referring now to the drawings in FIGS. 1-4, wherein similar parts are identified by like reference numerals, the device 10 is depicted in FIG. 1 in an as-mounted position upon and upper portion of the exterior of a pipe section 12. The safety line anchor device 10 includes a base member 16 which has a body or bottom surface 18 curved in an arc such that the bottom surface 18 of the base member 16 follows the same curve as, and will contact, the arc of the curved exterior surface 20 of a pipeline or pipeline section 12.

To achieve the proper curve of the bottom surface 18, the device 10 can be manufactured from material with a fixed curve and adapted to fit a certain diameter pipeline section 20 such as metal or substantially rigid plastic. Or, in a particularly preferred mode of the device 10, the base member 16 is malleable and will bend and adapt to diametered pipe with different arcs of their exterior surface 20.

If formed in a single body type component, the base member 16 as shown in FIG. 1 would be arced such that its bottom surface 20 matches the curve of the desired exterior surface 20. However, as noted, forming the base member of a malleable material such as reinforced rubber, plastic, or from recycled tires, will allow it to adapt to virtually any curve of the exterior surface 20 of the pipeline, and this would be the most preferred mode of the device due to its adaptability. Such reinforced rubber or polymer or plastic material is employed, for instance, in tires which also employ an internal steel or fiber reinforcement of the vulcanized rubber or other synthetic material forming the tire body and thereby forms a very strong, but very bendable layer. Consequently, the base member 16 can be made from a center section of recycled tires such as the portion with tread on one surface, or other reinforced rubber or plastic material that will provide a good mount for the eyes 26 or other means for engagement for a tether.

In the disclosed device 10, the base member 16 would have a construction similar with bendable or malleable material being sufficiently reinforced to allow for tensioning by the mounting strap 22 when engaged and to maintain the means for engagement of the safety tether 24 to the base member 16 which is shown as eyes 26 upon the base member 16. The flexible reinforced rubber or plastic material also provides a very good frictional engagement with the exterior surface 20 of the pipe section 12 when placed in a tensional engagement with the strap 22 making such a material particularly preferred. Further, a flexible member 16 will tend to stretch slightly when tensioned by the strap 22 increasing its grip upon the exterior of the pipe.

The engagement components providing means for engagement to the safety tether 24 each project above the top surface 28 of the base member 16 and can be provided in one or a plurality of engagement components. The shown eyes 26 would provide an excellent engagement to snap hooks 28 on the distal end of the tether 24; however, those skilled in the art will no doubt ascertain other means for engagement to a tether 24 and such are anticipated.

As noted, engagement of the base member 16 to the exterior surface 20 of the pipe section 12 or pipeline, without actually attaching a component to the exterior surface 20 which might damage the pipe section 12, is provided by a strap 22 having a length sufficient to encircle the pipe section 12. The strap 22 engages opposite ends of the base member 16 using snap hooks 28 engaged through eyes 26, or other means for engagement of the two ends of the strap 22 in an engagement adjacent to the two ends of the base member 16. The strap 22 is pulled to a tight fit around the pipe section 12 to impart a tensioned engagement to both ends of the base member 16, thereby frictionally engaging the bottom surface 18 of the base member 16 to the exterior surface 20 of the pipe section 12 on which it engages. Where a flexible base member 16 is employed, this tension will tend to slightly stretch the base member 16 and achieve an especially good frictional engagement to the exterior surface 20.

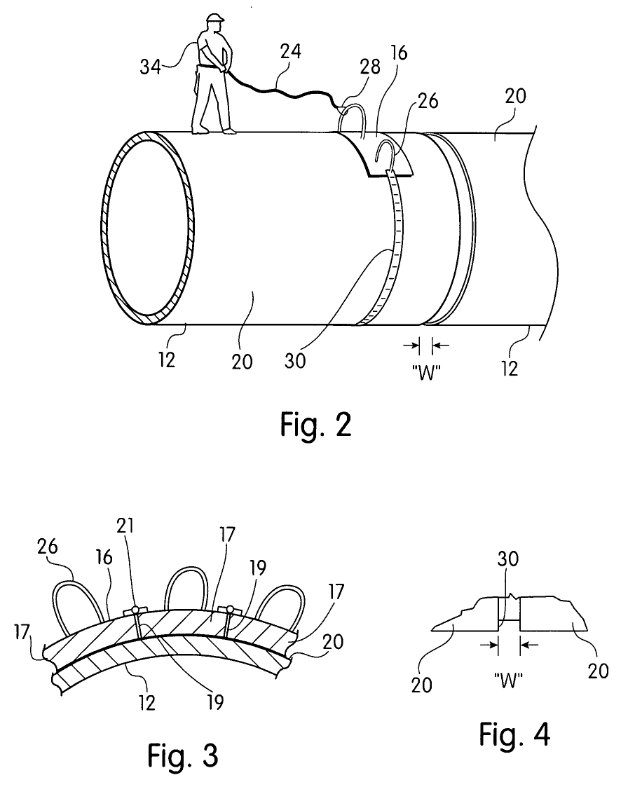

Shown in FIG. 2, where pipeline sections 12 are formed of cementitious material such as concrete, the strap 22 may be formed with a width which is slightly smaller than the width of the recess 30 that forms in the exterior surface 20 between engaged pipe sections 12 adjacent to the bell spigot engagement of two pipe ends. This recess has a width “W” and is formed when a nipple or projecting recessed portion on one end of a pipe section 12 engages within the interior surface of an adjoining pipe section 12. During experimentation with the device 10, it was found that employing a strap 22 having a width slightly smaller than that of the recess width “W” provided an especially easy means to pass the strap under the pipe when it was supported on the ground. Consequently, a strap adapted with a width less than the recess width “W” is especially preferred.

In conditions where the pipe sections 12 are to be welded at their communicating ends, it would be important to offset the mount of the device 10 from the bell and spigot engagement to allow for easy welding without damage to the strap or base member 16 or other components. Therefore the device 10 is adapted for either type of engagement around the pipe.

As noted, a curved bottom surface of the base member 16 is especially important to the device 10 and its engagement to a pipe 12. An alternative embodiment of the device 10 may feature another manner in which to achieve a means to adjust the curve of the base member 16 other than employing flexible material. As shown in FIG. 3, the base member 16 might also be formed of individual sections 17 which are joined across small gaps 19 by hinges 21 or other means for rotational engagement of the sections 17. Using this mode of the device 10 the sections 17 are rotatable in relation to each other to adjust the arc of the base member 16 to the arc of the exterior surface 20 of a pipe. The small gaps 19 allow the sections 17 to over rotate on the hinges 19 to accommodate smaller arcs in the exterior surface 20. Additionally, each section 17 would have its own grip upon the surface of the pipe 12.

In use, the base member 16, whether in a fixed arc or having means to adjust the arc of the base member 16, is frictionally engaged to the exterior surface 20 of the pipe section 12 or a finished pipeline. This is accomplished by placing the base member 16 on an upper surface area and securement of the strap 22 to both ends and around the pipeline. With the two ends of the strap 22 engaged to the two ends of the base member 16, the strap is tensioned by pulling upon one end past its engagement to the member 16 and then securing the strap 16 in that tensioned state using a buckle 32 or other means to hold the distal end of the strap 22 in the tensioned engagement.

Once the base member 16 is secured to the exterior surface 20, a worker 34 may thereafter engage the distal end of a safety harness tether 24 to the appropriate engagement component shown as an eye 26 of the base member 16 and be safely secured. So long as the tether 24 is of a length to protect the worker 34 from falling to the ground, the worker is protected if he or she should fall.

While all of the fundamental characteristics and features of the pipe engageable safety line anchor have been disclosed and described, with reference to particular embodiments thereof, a latitude of modification, various changes and substitutions are intended in the foregoing disclosure, and it will be apparent that in some instance, some features of the invention will be employed without a corresponding use of other features without departing from the scope of the invention as set forth. It should be understood that such substitutions, modifications, and variations may be made by those skilled in the art without departing from the spirit or scope of the invention. Consequently, all such modifications and variations are included within the scope of the invention as defined herein.

What is claimed is:

1. A pipeline-engageable safety line anchor, comprising:
a base member having a first end, a second end opposite said first end, a top surface and a bottom surface;
said bottom surface having a curved surface, said curved surface adapted to substantially match an arc of the exterior surface of a pipe on which said anchor is to engage;
means for removable engagement of said base member to said exterior surface of said pipe, to a mounted position; and
means for engagement of a first end of a tether to said base, said first end of said tether being opposite a second end of said tether adapted for engagement to a user.

2. The pipeline-engageable safety line anchor of claim 1 additionally comprising:
said base member is formed of substantially rigid material.

3. The pipeline-engageable safety line anchor of claim 1 additionally comprising:
said base member is formed of flexible material;
said flexible material providing means for said bottom surface to adapt to a curve defined by said arc of said exterior surface of a pipe; and
said base member thereby adaptable to a said mounted position on a plurality of different said pipes each having a different said curve to said exterior surface.

4. The pipeline-engageable safety line anchor of claim 3 additionally comprising:
said base member being formed of malleable rubber or plastic material.

5. The pipeline-engageable safety line anchor of claim 4 additionally comprising:
said malleable rubber or plastic material being a portion of a tire.

6. The pipeline-engageable safety line anchor of claim 1 wherein said means for removable engagement of said base member to said exterior surface of said pipe comprises:
an elongated strap having a first end and having a second end;
means to engage said first end of said strap adjacent to one of said first or second end of said member;
means to engage said second end of said strap adjacent to the other of said first or second end of said member; and
means to cinch said strap around said pipe in a tensioned engagement.

7. The pipeline-engageable safety line anchor of claim 1 wherein said means for removable engagement of said base member to said exterior surface of said pipe comprises:
an elongated strap having a first end and second end;
means to engage said first end of said strap adjacent to one of said first or second end of said member;
means to engage said second end of said strap adjacent to the other of said first or second end of said member;
means to cinch said strap and thereby imparting a tensioning force to said strap, said tensioning force being communicated to said first and second ends of said member; and
said tensioning force providing a force on said member toward said pipe, said force providing a frictional engagement of said bottom surface of said base member upon said exterior surface of said pipe.

8. The pipeline-engageable safety line anchor of claim 2 wherein said means for removable engagement of said base member to said exterior surface of said pipe comprises:
an elongated strap having a first end and having a second end;
means to engage said first end of said strap adjacent to one of said first or second end of said member;
means to engage said second end of said strap adjacent to the other of said first or second end of said member; and
means to cinch said strap around said pipe in a tensioned engagement.

9. The pipeline-engageable safety line anchor of claim 2 wherein said means for removable engagement of said base member to said exterior surface of said pipe comprises:
an elongated strap having a first end and second end;
means to engage said first end of said strap adjacent to one of said first or second end of said member;
means to engage said second end of said strap adjacent to the other of said first or second end of said member;
means to cinch said strap and thereby imparting a tensioning force to said strap, said tensioning force being communicated to said first and second ends of said member; and
said tensioning force providing a force on said member toward said pipe, said force providing a frictional engagement of said bottom surface of said base member upon said exterior surface of said pipe.

10. The pipeline-engageable safety line anchor of claim 3 wherein said means for removable engagement of said base member to said exterior surface of said pipe comprises:
an elongated strap having a first end and having a second end;
means to engage said first end of said strap adjacent to one of said first or second end of said member;
means to engage said second end of said strap adjacent to the other of said first or second end of said member; and
means to cinch said strap around said pipe in a tensioned engagement.

11. The pipeline-engageable safety line anchor of claim 3 wherein said means for removable engagement of said base member to said exterior surface of said pipe comprises:
an elongated strap having a first end and second end;
means to engage said first end of said strap adjacent to one of said first or second end of said member;
means to engage said second end of said strap adjacent to the other of said first or second end of said member;
means to cinch said strap and thereby imparting a tensioning force to said strap, said tensioning force being communicated to said first and second ends of said member; and
said tensioning force providing a force on said member toward said pipe, said force providing a frictional engagement of said bottom surface of said base member upon said exterior surface of said pipe.

12. The pipeline-engageable safety line anchor of claim 6 additionally comprising:
said means to engage said first end of said strap adjacent to one of said first or second end of said member being a first fastener on said first end of said strap said first fastener cooperatively engageable with a second fastener engaged to said member; and
said means to engage said second end of said strap adjacent to the other of said first or second end of said member being a third fastener on said second end of said strap said third fastener cooperatively engageable with a fourth fastener engaged to said member.

13. The pipeline-engageable safety line anchor of claim 7 additionally comprising:
said means to engage said first end of said strap adjacent to one of said first or second end of said member being a first fastener on said first end of said strap said first fastener cooperatively engageable with a second fastener engaged to said member; and
said means to engage said second end of said strap adjacent to the other of said first or second end of said member being a third fastener on said second end of said strap said third fastener cooperatively engageable with a fourth fastener engaged to said member.

14. The pipeline-engageable safety line anchor of claim 9 additionally comprising:
said means to engage said first end of said strap adjacent to one of said first or second end of said member being a first fastener on said first end of said strap said first fastener cooperatively engageable with a second fastener engaged to said member; and
said means to engage said second end of said strap adjacent to the other of said first or second end of said member being a third fastener on said second end of said strap said third fastener cooperatively engageable with a fourth fastener engaged to said member.

15. The pipeline-engageable safety line anchor of claim 10 additionally comprising:
said means to engage said first end of said strap adjacent to one of said first or second end of said member being a first fastener on said first end of said strap said first fastener cooperatively engageable with a second fastener engaged to said member; and
said means to engage said second end of said strap adjacent to the other of said first or second end of said member being a third fastener on said second end of said strap said third fastener cooperatively engageable with a fourth fastener engaged to said member.

16. The pipeline-engageable safety line anchor of claim 11 additionally comprising:
said means to engage said first end of said strap adjacent to one of said first or second end of said member being a first fastener on said first end of said strap said first fastener cooperatively engageable with a second fastener engaged to said member; and
said means to engage said second end of said strap adjacent to the other of said first or second end of said member being a third fastener on said second end of said strap said third fastener cooperatively engageable with a fourth fastener engaged to said member.

17. The pipeline-engageable safety line anchor of claim 8 additionally comprising:
said strap having a width;
said width being substantially equal to or less than a width dimension of a recess formed in said exterior surface of said pipe at an engagement point between two said pipes, said recess formed adjacent to a bell section of one said pipe engaged with a spigot section of another said pipe; and
said recess defining a circumferential path around said exterior surface of said pipe for said strap.

18. The pipeline-engageable safety line anchor of claim 14 additionally comprising:
said strap having a width;
said width being substantially equal to or less than a width dimension of a recess formed in said exterior surface of said pipe at an engagement point between two said pipes, said recess formed adjacent to a bell section of one said pipe engaged with a spigot section of another said pipe; and
said recess defining a circumferential path around said exterior surface of said pipe for said strap.

19. The pipeline-engageable safety line anchor of claim 15 additionally comprising:
said strap having a width;
said width being substantially equal to or less than a width dimension of a recess formed in said exterior surface of said pipe at an engagement point between two said pipes, said recess formed adjacent to a bell section of one said pipe engaged with a spigot section of another said pipe; and
said recess defining a circumferential path around said exterior surface of said pipe for said strap.

20. The pipeline-engageable safety line anchor of claim 16 additionally comprising:
said strap having a width;
said width being substantially equal to or less than a width dimension of a recess formed in said exterior surface of said pipe at an engagement point between two said pipes, said recess formed adjacent to a bell section of one said pipe engaged with a spigot section of another said pipe; and
said recess defining a circumferential path around said exterior surface of said pipe for said strap.

21. The pipeline-engageable safety line anchor of claim 1 additionally comprising:
said base member formed of a plurality of member segments;
each said member segment rotationally engaged to adjacent said member segments; and
said base member formed of said member segments thereby forming a flexible base member adaptable to a said mounted position on a plurality of different said pipes each having a different said curve to said exterior surface.
